(19) United States
(12) Patent Application Publication
(10) Pub. No.: US 2008/0047664 A1
(43) Pub. Date: Feb. 28, 2008

(54) T-TABBED DOUBLE-SIDED TAPE AND METHOD OF PREPARATION

(76) Inventor: Joseph P. McGee, Kinmount (CA)

Correspondence Address: STANDLEY LAW GROUP LLP, 495 METRO PLACE SOUTH, SUITE 210, DUBLIN, OH, 43017, US

(21) Appl. No.: 11/834,300

(22) Filed: Aug. 6, 2007

Related U.S. Application Data
(60) Provisional application No. 60/821,420, filed on Aug. 4, 2006.

(51) Int. Cl. C09J 7/02

(52) U.S. Cl. 156/289; 156/537; 428/317.3; 428/352

(57) ABSTRACT

An improved double-sided adhesive tape has an elongate carrier strip, with a length and width defining a pair of opposing planar faces that are separated by a thickness that is substantially smaller than either the length or width, a layer of pressure-sensitive adhesive applied to each of the opposing faces along the length, and a release liner strip in removable registration atop one of the adhesive layers. The improvement in the tape is provided by a loop formed between the release liner strip and the adhesive layer upon which it is in registration, the loop defined by bending a length of the release liner out of registration with the adhesive layer before resuming the registration. A method and machine for manufacturing the improvement structure are also provided.

### CROSS-REFERENCE TO RELATED APPLICATIONS

This application claims the benefit of priority to U.S. provisional application 60/821,420, filed 4 Aug. 2006, which is incorporated by reference as if fully recited herein.

### TECHNICAL FIELD

The present invention relates to double-sided tape and an improved method of applying it. In particular the invention relates to an improved tabbed tape and method of removing the liner from double-sided tape.

### BACKGROUND OF THE ART

As is well known double-sided tape must be provided with a liner that prevents the two adhesive surfaces of the tape from bonding to adjacent objects and/or each other. When double-sided tape is used to bond two surfaces together, usually the first adhesive layer is applied to the first surface. The tape liner is present and protects the second adhesive layer, until the second surface is required to be bonded. This is accomplished by first removing the liner from the second adhesive layer of the tape and then bonding the second adhesive layer of the tape to the second surface.

Removing the liner from the second adhesive layer of the tape requires breaking the bond between the protective liner and the tape at one end or the other. Usually a fingernail or sharp object is used to separate the liner. This operation necessarily causes damage to the expensive adhesive surface, impeding the proper bonding of the tape to the second surface. Moreover, this operation causes stress to be applied to the end of the tape, which often results in the tape being lifted off the first surface at this stress point. Various methods have been attempted to minimize or eliminate the damage to the adhesive surface and the lift-off effect at the stress point.

One method uses an extended tab, which protrudes beyond the end of the tape. This is done by cutting some of the adhesive portion of the tape away and leaving a portion of the liner extending beyond the tape, which can be easily grasped for removal. This method is wasteful, in that a portion of the expensive adhesive is thrown away. The method also introduces the problem of impacting the integrity of the liner. When the adhesive portion of the tape is cut there is the possibility of also cutting the liner, especially when the cutting method used is die stamping. Another limitation of this method is that only one tab at the end of the tape is provided. This is especially limited in the case where the length of the tape is large, such as, for example, when wound into rolls.

Another method is to pre-start the liner, which is costly and ineffective. It is desirable to provide a more efficient and cost-effective way to remove liner from double-sided tape, without the damaging effects on the tape or the liner.

### SUMMARY OF THE INVENTION

The present invention comprises a method to remove easily and without damage the liner from double-sided tape before the tape is bonded to a surface. The invention also relates to double-sided tape with a special T-shaped tab, which facilitates in the removal of the liner.

The method for applying a release liner to an exposed surface of an adhesive tape has the steps of: a) anchoring a portion of the release liner along a portion of the exposed surface of the tape; b) establishing a slack in an un-anchored portion of the release liner; and c) re-anchoring a portion of the release liner to a portion of the adhesive tape, the re-anchoring occurring at a distance along the release liner from the un-anchored slack forming a loop of the release liner along the length of the adhesive tape.

Another method for applying a release liner to an exposed side of double-sided adhesive tape has the steps of: a) unrolling a roll of double-sided adhesive tape; b) unrolling a roll of release liner across a lifting plate; c) anchoring a portion of said release liner to a portion of said double-sided tape beyond an end of said lifting plate; d) lifting said lifting plate; e) dropping said lifting plate to create a slack in the un-anchored portion of said release liner; f) re-anchoring a portion of said release liner on the opposite side of said slack to a portion of said double-sided adhesive tape such that said slack forms a loop between said release liner and said double-sided adhesive tape; and g) rolling a roll of double-sided adhesive tape with release liner attached.

With respect to the latter method, in some cases, the double-sided adhesive tape of said unrolling step has a carrier liner in removable registration atop one of the adhesive sides.

In some cases, the lifting step further comprises lifting a lifting arm connected to said lifting plate.

In some cases, the dropping step further comprises dropping a lifting arm connected to said lifting plate. Further, some dropping steps are accomplished by connecting the lifting arm to said lifting plate with a wire.

One way to perform the lifting step is to lift the lifting arm using a cam profile attached to a cam wheel. The cam wheel, in some cases, is rotated by a drive wheel, which may or may not involve a pulley system. A spindle may be connected to the drive wheel.

A system for applying a release liner to an exposed side of double-sided adhesive tape may comprise: a lifting plate; a roll of double-sided adhesive tape; a roll of release liner, said roll of release liner adapted to unroll atop said lifting plate; a means to lift and drop said lifting plate to create a slack in said release liner; a means to adhere said release liner to said double-sided adhesive tape such that said slack forms a loop between said release liner and said double-sided adhesive tape; and a means to roll said double-sided adhesive tape with said release liner attached.

In such a system, the double-sided adhesive tape has a carrier liner in removable registration atop one of the adhesive sides.

The system can also comprise a lifting arm connected to said lifting plate adapted to lift and drop said lifting plate, especially where the lifting arm is connected to said lifting plate with a wire.

In some variations, a cam profile attached to a cam wheel lifts and drops the lifting arm, especially where a drive wheel rotates the cam wheel. More especially, a pulley system can be used by the drive wheel to drive the cam wheel.

In some embodiments, a means for releasing compressed air can bond said release liner to said double-sided adhesive tape. Some of these embodiments will use a trigger knob mounted on said cam wheel, said trigger knob adapted to control the release of said compressed air.

A guide roller may be used to guide said double-sided adhesive tape and said release liner to said rolling means.

An improved double-sided adhesive tape taught in more detail below comprises an elongate carrier strip, with a length and width defining a pair of opposing planar faces that are separated by a thickness that is substantially smaller than either the length or width, a layer of pressure-sensitive adhesive applied to each of the opposing faces along the length, and a release liner strip in removable registration atop one of the adhesive layers, the improvement comprising a loop formed between said release liner strip and the adhesive layer upon which it is in registration, said loop defined by bending a length of the release liner out of registration with the adhesive layer before resuming the registration.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which identical parts are identified with identical reference numerals and in which:

FIG. 1 is a sectional view of a portion of a double-sided tape having the improvement of a T-shaped tab in the release liner, with one side bonded to a surface;

FIG. 2 is a side view of a machine for manufacturing the improved double sided tape;

FIG. 3 is an isolated enlargement of a portion of the FIG. 2 machine; and

FIGS. 4a and 4b are isolated enlargements of a portion of the FIG. 2 machine, illustrating the formation of the tab along the release liner.

### DESCRIPTION OF A PREFERRED EMBODIMENT

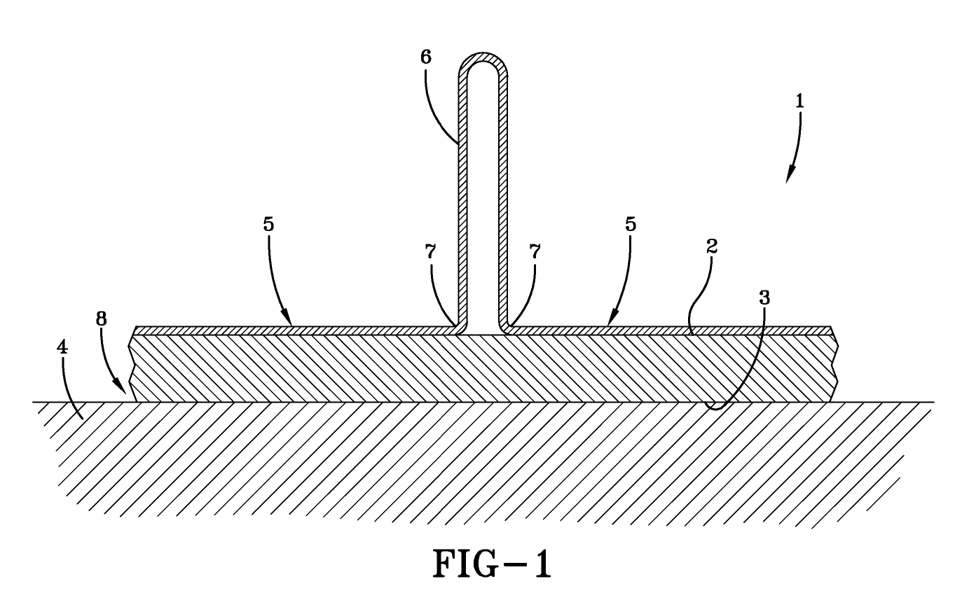

Referring first to FIG. 1, an improved double-sided tape 1 is shown. The tape 1 is a carrier strip with a top side 2 and a bottom side 3, each of which has had an adhesive coating, particularly a pressure-sensitive adhesive (PSA) coating applied to them. Both the tape and the adhesive will be familiar to those of skill in the art. For example, the tape will typically be a polymeric film, especially a polyethylene film. The adhesive, especially the pressure-sensitive adhesive, will typically be an acrylate material. In many embodiments that will be familiar to those in the art, the tape 1 is an elongate web of the material having a defined width and a very long length, the thickness of the tape being substantially smaller than even the width. The PSA is applied using known techniques in a thin layer on each of the surfaces 2, 3.

In the depicted embodiment, the bottom side 3 of the tape 1 is shown after a protective release liner has been removed to permit adhesion to a surface 4. In a tape 1 of this type as known in the prior art, the release liner will have been applied in a continuous registration atop the surface 4. The release liner will typically be of the same composition as the tape, although it may be thinner, as it need not display the same strength and/or longevity as the tape. Because the release liner has been coated with a specific coating, usually a silicone material, to which the PSA does not adhere as aggressively as to the surface of the tape 1, peeling of the release liner off of the tape leaves the PSA effectively intact on the tape. However, the primary focus of many prior attempts at facilitating peel of the release liner have been directed at weakening of the release liner itself, as with perforations, scorings, or the like, or at providing a release liner that is thin when compared to the tape. As these strategies are implemented prior to registration, to avoid damaging the tape, they implicitly impair the strength of the web of release liner during the registration process. Also, techniques that disrupt the continuity of the release liner on the tape pose the potential of exposing the PSA prematurely, allowing it to be contaminated by dirt, dust, moisture and the like.

However, and as readily viewed, albeit in a rather exaggerated manner, the solution provided herein is to provide a tape in which a length of the release liner 5 is bent out of strict registration with the tape while it is being applied to the tape. By doing this, a loop of the release liner material is formed that extends away from the tape. The loop, which rejoins the tape in registration at a position very close to the point from which it departs from registration with the tape, provides a tab 6 with a general “T” shape in which the tape represents the cross member of the “T” and the loop represents the upright member.

When top side 2 of tape 1 is required to be bonded to a second surface, the liner 5 is removed to expose the adhesive coating of top side 2. This is accomplished by a simple lifting motion of tab 6, which releases the liner at edges 7, thereafter promoting the easy removal of the entire liner.

The integral construction of the tab 6 with liner 5 has the advantage that a single pulling motion of the tab 6 commences the removal of liner 5 from tape 1 in both directions. Optionally, the tab 6 can be cut at its apex to allow dispensing of the liner 5 in two stages.

As can be seen from FIG. 1 the tab 6 is located at a distance from edge 7 of tape 1. The advantage of locating the tab 6 away from edge 7 is that during the operation of removing liner 5 the disengagement of liner 5 from the top adhesive side 2 takes place in a direction toward the edge 7. This eliminates the “lift-off” effect that would occur at stress point 8 if the lifting of the liner 5 took place in the opposite direction and provides superior bonding between the two surfaces.

In addition to eliminating the damage to the adhesive surface and the lift-off effect of conventional double-sided tape release liners, the T-tabbed tape also has the advantage of providing an easy and time-efficient way of removing the release liner as compared to prior art release liners. Additionally, as tab 6 is constructed of the same thin material as liner 5, it can easily be folded down such that the tape 1 can be wound into rolls or, if required, pre-cut strips of T-tabbed tape can be stacked one on top of another.

Another advantage of the tab over prior art, such as the extended tab, for example, is that several T-tabs can be provided, spaced within the length of the double-sided tape, as opposed to only one tab at the end of the tape.

Placement of the release liner 5 in this looped fashion atop the tape 1 allows the web of tape to be wound upon itself in a roll, so that it may be dispensed in a manner similar to that used with conventional single-sided adhesive tape. In rolling the web up into a roll, each loop of the release liner folds downwardly onto the registered release liner. This folding of the loop also permits lengths of the double-sided adhesive tape 1 to be stacked atop each other, the release liner 5, and particularly the loops formed therein, facilitating the separation of the individual lengths from each other.

In one embodiment, some or all of the loops may be cut, especially transversely and most especially at an apex of the loop. This allows the divided loop ends to serve as tabs which may be readily grasped and pulled to perform the peeling operation.

While the illustrated embodiment shows a single loop formed in the release liner along its registration on the tape 1, it will be obvious that a plurality of the loops may be formed along a given length of the tape. The longitudinal spacing of the loops along the tape 1 would preferably be regular, and this will in many cases be the natural result of the manufacturing process. However, irregular spacing would generally not impede the utility of a tape having the irregularly-spaced loops.

In a preferred embodiment, tab 6 extends vertically to a desired length of about 1″ from the top side 2 of tape 1. This allows a sufficient amount of the liner 5 to be free of adhesion with the PSA to permit a secure grip by a user.

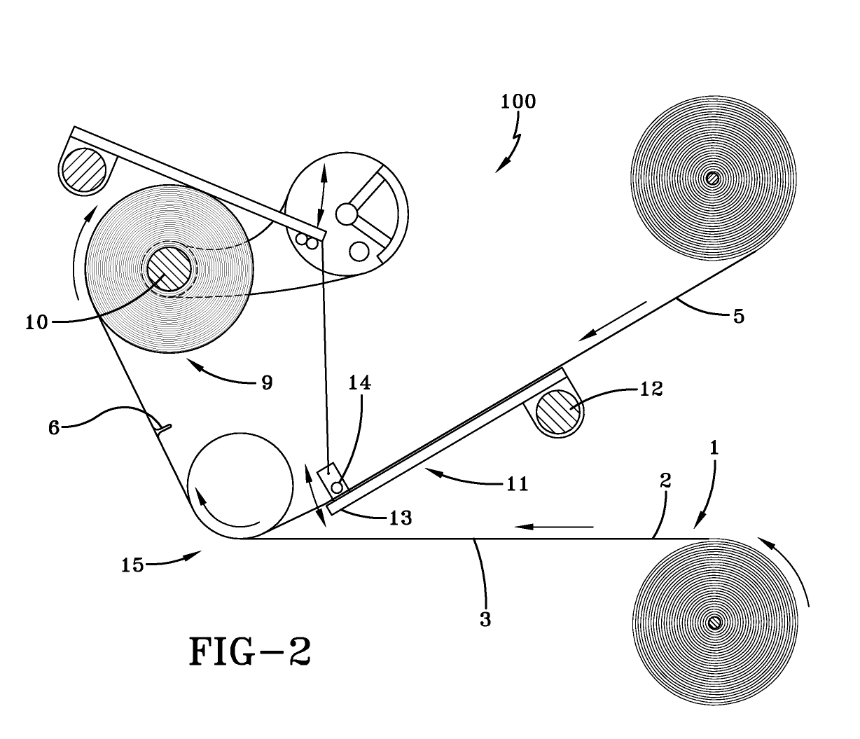

A machine and method of assembling the tape construction described above. These are illustrated in FIGS. 2 through 4b.

Beginning with FIG. 2, the device 100 consists of two feed rolls, one for the protective liner 5 and one for the tape 1. The tape 1, earlier joined with the carrier liner (not shown) on the bottom side 3, has a top side 2 free to bind with the protective liner 5. After the protective liner 5 is bonded to the tape 1 with the formation of tab 6, the material is collected into a final tape log 9 onto a winding roll 10.

From their respective feed rolls, the protective liner 5 is drawn over a metal platen or lifting plate 11 and the tape 1 travels underneath, where both layers then make contact after the said lifting plate 11, proximate to a guide roller described below. The lifting plate 11 is rotatably fixed at one end to a support beam 12 and is free at an opposite end 13, where the protective liner 5 joins the adhesive 1. Thus, the lifting plate 11 rotates about its fixed support beam 12, raising and lowering its free end 13. The free end 13 of the lifting plate 11 also has a compressed air line 14 mounted along its length to urge the protective liner 5 against tape 1. The tape is then fed under the guide roller 15, as mentioned above.

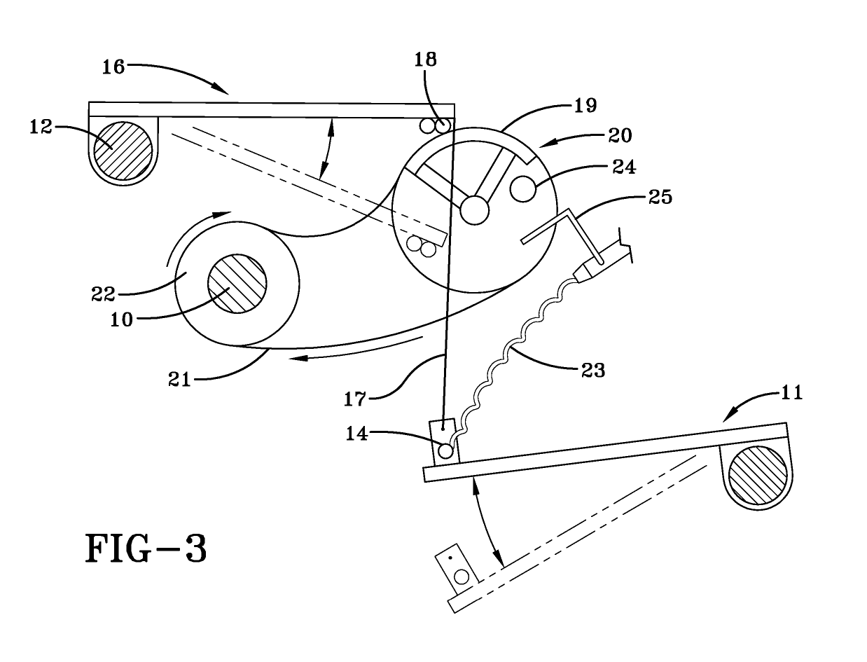

As demonstrated in FIG. 3, which isolates some of the elements from FIG. 2 to focus better on their operation, the movement of the lifting plate 11 is controlled by a lifting arm 16. The lifting arm 16 is connected by a wire 17 to the lifting plate 11. The lifting arm 16 acts as a lever; its tail end being rotatably attached to another fixed support beam 12 and its head end having a cam follower 18. The said cam follower 18 is controlled by a cam profile 19 on a cam wheel 20. The cam wheel 20 is connected by a pulley belt 21 to a drive wheel 22, which is coupled onto the said winding roll 10. The rotational motion of the winding roll 10 turns the coupled drive wheel 22 and through the pulley belt 21, the cam wheel 20 is also turned. The pulley belt 21 connecting the drive wheel 22 to the cam wheel 20 is fitted by a tensioning arm (not shown) to allow different sizes of drive wheels to function within one assembly. As the cam wheel 20 rotates, the cam follower 18 interacts with the cam profile 19, raising and dropping the lifting arm 16. The movement of the lifting arm 16 controls the hinged lifting plate 11 through the connection of the wire 17.

The compressed air line 14 is mounted along the length of the free end 13 of the lifting plate 11 to firmly adhere the protective liner 5 to the tape 1. Furthermore, the guide roller 15 is located directly after the lifting plate 11 to apply pressure to the formed material to ensure binding is secure. Connected to said compressed air line 14 on said lifting plate 11, is a flexible air hose 23. A trigger knob 24 mounted on said cam wheel 20 controls the release of the compressed air line 14. The trigger knob 24 makes contact with a valve switch 25 for the flexible air hose 23 to release air at said mounted air line 14. Immediately after the lifting plate 11 has fallen to its lowered position, the trigger knob 25 engages and opens the valve switch 25 on the flexible air hose 23, releasing air from the mounted line 14 onto the loop 26 and adhesive 1. The liner 5, loop 26, and adhesive 1 then run through the guide roller 15 and are wound up in the final tape log 9

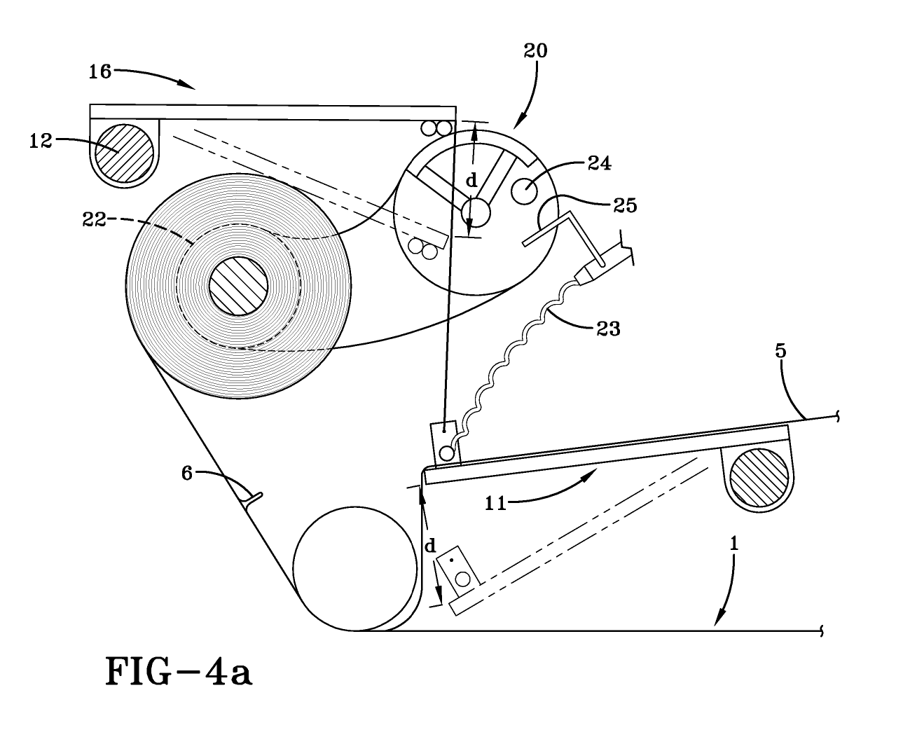

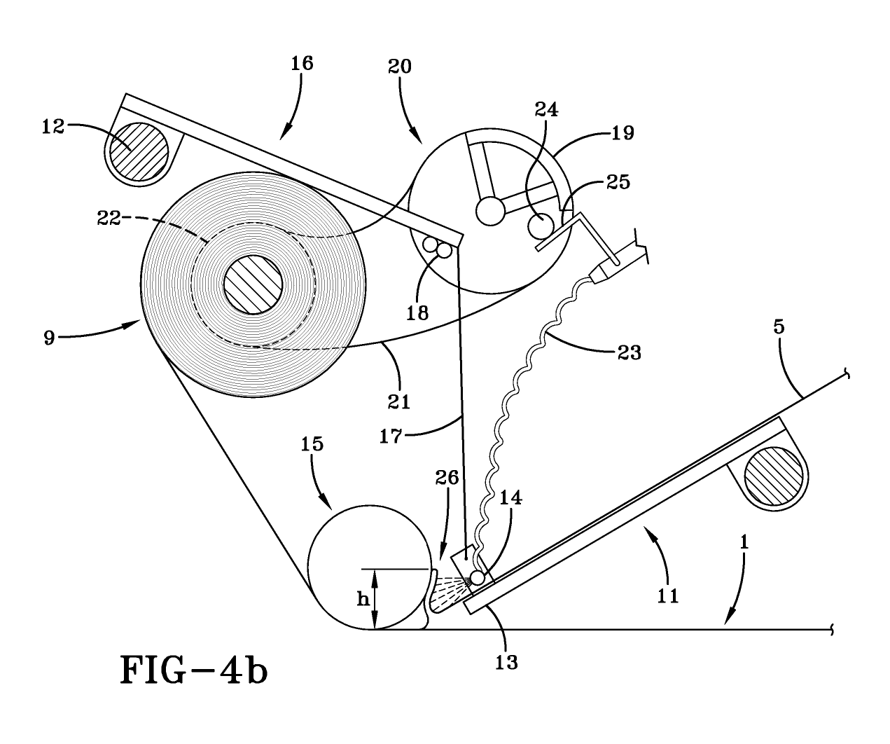

The tabs 6 are formed by the creation of slack in the protective liner 5 by the lifting plate 11. It is illustrated in FIG. 4(a) that as the lifting arm 16 rises a distance d it also raises the lifting plate 11 a distance d, and the liner 5 must travel over the lifting plate 11 and down to the adhesive 1 at a 90° angle. Then, as shown in FIG. 4(b), as the cam follower 18 disengages from the cam profile, the lifting arm rotates about its support beam 12, suddenly dropping the lifting plate 11. A loop 26 of protective liner 5 is trapped from the slack formed by the distance the protective liner 5 had to travel from the free end 13 to the tape 1 when the lifting plate 11 was raised. It is this loop structure 26 that forms the tab 6 attribute within the tape log 9. The loop 26 is formed from a fold in the trapped protective liner 5.

The height of the tab 6 from the top surface 2 of the tape 1 is determined by the position of the lifting arm 16 with respect to the cam wheel 20. The lifting arm 16 is flexibly mounted to allow rotation about its support beam such that the cam follower 18 interacts with the cam profile 19 at a specific position and raises the cam follower 18 to a desired height. Therefore, the angle that the lifting arm 16 is mounted on its support beam 12 determines the point at which the cam follower 18 makes contact with the cam profile 19 and the height that the lifting arm 16 is raised. The distance that the lifting arm 16 is raised, d, is equal to the height the lifting plate 11 is also raised, d, due to the connecting wire 17. The height, h, of the loop 26 is consequently equal to half this distance, d. To ensure that the free end 13 of the lifting plate 11 will fall to its lowest position to make contact with top side 2 of adhesive 1, the wire 17 connecting the lifting arm 16 to the lifting plate 11 is adjusted as needed to correspond with the articulated mounting position of the lifting arm 16 on its fixed support beam 12. To fabricate T-tabs 6 of different heights, the lifting arm 16 must be repositioned on its support beam 12 so its cam follower 18 interacts with the cam profile 20 at a new height.

As stated, an advantage of the tab 6 is the ability to provide a plurality thereof spaced within the final tape log 9. The spacing of the tabs 6 is determined by controlling the angular speed of the cam wheel 20. This can be achieved through changing the diameter of the drive wheel 22, as the cam wheel 20 and drive wheel 22 are connected via the said pulley belt 21. The feature of this connection is the relationship between the angular speeds and diameters of the cam wheel 20 and drive wheel 22. As the drive wheel 22 is coupled to the winding roll 10, it turns with the same constant angular speed. Therefore, as known to one skilled in the art, by increasing the diameter of the drive wheel 22 and keeping the diameter of the cam wheel 20 constant, it subsequently increases the angular speed of the cam wheel. When the speed of rotation of the cam wheel 20 increases, more interaction cycles between the cam follower and cam profile occur, which lifts the lifting plate more frequently, and creates more T-tabs within a roll spaced closely together.

Sufficient slack must be present in the liner feed roll 5 to prevent the loop 26 material from being drawn back and coming off of the adhesive 1. A belt connection (not shown) between the winding roll 10 to the protective liner 5 feed roll keeps the protective liner 5 roll moving at a faster speed then the adhesive 1 roll to maintain slack.

Other advantages, which are inherent to the structure, are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed is:

1. A method for applying a release liner to an exposed side of double-sided adhesive tape comprising:
unrolling a roll of double-sided adhesive tape;
unrolling a roll of release liner across a lifting plate;
anchoring a portion of said release liner to a portion of said double-sided tape beyond an end of said lifting plate;
lifting said lifting plate;
dropping said lifting plate to create a slack in the un-anchored portion of said release liner;
re-anchoring a portion of said release liner on the opposite side of said slack to a portion of said double-sided adhesive tape such that said slack forms a loop between said release liner and said double-sided adhesive tape; and
rolling a roll of double-sided adhesive tape with release liner attached.

2. The method of claim 1, wherein:
said double-sided adhesive tape of said unrolling step has a carrier liner in removable registration atop one of the adhesive sides.

3. The method of claim 1, wherein said lifting step further comprises lifting a lifting arm connected to said lifting plate.

4. The method of claim 3, wherein said dropping step further comprises dropping a lifting arm connected to said lifting plate.

5. The method of claim 4, wherein said dropping step further comprises said lifting arm connected to said lifting plate with a wire.

6. The method of claim 4, wherein said lifting step further comprises lifting said lifting arm using a cam profile attached to a cam wheel.

7. The method of claim 6, further comprising a step of rotating said cam wheel using a drive wheel.

8. The method of claim 7, wherein said rotating step further comprises said drive wheel rotating said cam wheel using a pulley system.

9. The method of claim 8, wherein said rotating step further comprises connecting said drive wheel to a spindle.

10. The method of claim 9, wherein said rolling step further comprises rolling said double-sided adhesive tape with said release liner attached around said spindle.

11. The method of claim 6, wherein said adhering step further comprises releasing compressed air to bond said release liner to said double-sided adhesive tape.

12. The method of claim 11, wherein said adhering step further comprises controlling said releasing step using a trigger knob mounted on said cam wheel.

13. The method of claim 1, wherein said adhering step further comprises releasing compressed air to bond said release liner to said double-sided adhesive tape.

14. The method of claim 1, further comprising a step of running said double-sided adhesive tape with said release liner attached through a guide roller after said adhering step.

15. The method of claim 1, wherein said double-sided adhesive tape unrolling step further comprises unrolling the double-sided adhesive tape below said lifting plate.

16. The method of claim 1, wherein the step of unrolling the release liner is done at a higher rate than the step of unrolling the double-sided adhesive tape.

17. A system for applying a release liner to an exposed side of double-sided adhesive tape comprising:
a lifting plate;
a roll of double-sided adhesive tape;
a roll of release liner, said roll of release liner adapted to unroll atop said lifting plate;
a means to lift and drop said lifting plate to create a slack in said release liner;
a means to adhere said release liner to said double-sided adhesive tape such that said slack forms a loop between said release liner and said double-sided adhesive tape; and
a means to roll said double-sided adhesive tape with said release liner attached.

18. An improved double-sided adhesive tape, comprising:
an elongate carrier strip, with a length and width defining a pair of opposing planar faces that are separated by a thickness that is substantially smaller than either the length or width, a layer of pressure-sensitive adhesive applied to each of the opposing faces along the length, and a release liner strip in removable registration atop one of the adhesive layers, the improvement comprising:
a loop formed between said release liner strip and the adhesive layer upon which it is in registration, said loop defined by bending a length of the release liner out of registration with the adhesive layer before resuming the registration.

19. The double-sided adhesive tape of claim 18, wherein said release liner is in a general “T” shape.

20. The double-sided adhesive tape of claim 18, wherein said double-sided adhesive tape is dispensed from a roll.

21. The double-sided adhesive tape of claim 20, wherein the portion of said release liner not in registration with the adhesive surface is folded down when the double-sided adhesive tape is in said roll.

22. The double-sided adhesive tape of claim 18, wherein said double-sided adhesive tape is dispensed from a stack of double-sided adhesive tape.

23. The double-sided adhesive tape of claim 22, wherein the portion of said release liner not in registration with the adhesive surface is folded down when the double-sided adhesive tape is in said stack.

24. The double-sided adhesive tape of claim 18, wherein said release liner is cut at the apex of said loop.
